(19) United States
(12) Patent Application Publication
(10) Pub. No.: US 2026/0064730 A1
(43) Pub. Date: Mar. 5, 2026

(54) INQUIRY ANSWERING SYSTEM, INQUIRY ANSWERING METHOD, AND INFORMATION STORAGE MEDIUM

(71) Applicant: Rakuten Group, Inc., Tokyo (JP)

(72) Inventors: Takaya KASUGA, Tokyo (JP); Satoshi TANAKA, Tokyo (JP); Taro MORIYAMA, Tokyo (JP)

(21) Appl. No.: 19/310,939

(22) Filed: Aug. 27, 2025

(30) Foreign Application Priority Data
Aug. 29, 2024 (JP) 2024-147776

(51) Int. Cl. G06F 16/332; G06F 16/35

(52) U.S. Cl. CPC G06F 16/3323; G06F 16/35

(57) ABSTRACT

Provided is an inquiry answering system including at least one processor configured to: acquire inquiry information relating to an inquiry from a user in a predetermined service; acquire classification information relating to a classification that relates to the inquiry and that is defined in advance in the predetermined service; input the inquiry information and the classification information to a large language model to acquire a model answer relating to the classification and a certainty degree of the classification which are generated by the large language model; and control output of the model answer based on the certainty degree.

### CROSS-REFERENCE TO RELATED APPLICATION

The present application claims priority from the Japanese patent application JP2024-147776, filed on Aug. 29, 2024, the disclosures of which are incorporated by reference herein.

### BACKGROUND OF THE INVENTION

### 1. Field of the Invention

The present disclosure relates to an inquiry answering system, an inquiry answering method, and an information storage medium.

### 2. Description of the Related Art

Hitherto, there has been known a technology for supporting answering an inquiry received from a user in a predetermined service. For example, in Japanese Patent No. 7445108, there is described an intermediary device which transmits one or more topics to an artificial intelligence as topic information, selects, based on the topic information, on condition that the artificial intelligence notifies that a conversation with a user is a specified conversation being a conversation including any one of one or more topics, a product to be promoted which relates to the specified conversation from one or more products, and executes insertion processing for inserting, into the conversation, promotion information for promoting to the user the selected product to be promoted.

For example, in Japanese Patent Application Laid-open No. 2019-185191, there is described an FAQ support device which includes a bot which holds, as a plurality of pieces of frequently asked question (FAQ) information, inquiries being expected inquiries from a client operated by a user and wording of answers relating to those inquiries in advance in an FAQ data file, and executes search processing of presenting, to the client, inquiry candidates obtained by narrowing down corresponding FAQ information based on an selection operation for a category or a tag relating to the FAQ information, at a time of an inquiry from the client.

### SUMMARY OF THE INVENTION

However, the intermediary device of Japanese Patent No. 7445108 can insert an advertisement into the conversation between the user and the artificial intelligence, but uttered content of the user is simply content of a chat with the artificial intelligence, and hence, with the technology of Japanese Patent No. 7445108, it is not possible to accurately respond to the inquiry from the user in a predetermined service. The FAQ support device of Japanese Patent Application Laid-open No. 2019-185191 can only present the FAQ information corresponding to the category or the tag defined in advance, and hence cannot respond to an unknown inquiry. Thus, with the related-art technologies, the accuracy of the answer to the user cannot be fully increased in some cases.

One object of the present disclosure is to increase accuracy of an answer to a user who has made an inquiry in a predetermined service.

According to at least one embodiment of the present disclosure, there is provided an inquiry answering system including at least one processor configured to: acquire inquiry information relating to an inquiry from a user in a predetermined service; acquire classification information relating toa classification that relates to the inquiry and that is defined in advance in the predetermined service; input the inquiry information and the classification information a large language model to acquire a model answer relating to the classification and a certainty degree of the classification which are generated by the large language model; and control output of the model answer based on the certainty degree.

### BRIEF DESCRIPTION OF THE DRAWINGS

FIG. 1 is a diagram for illustrating an example of a hardware configuration of an inquiry answering system.

FIG. 2 is a diagram for illustrating an example of processing executed when a user makes an inquiry on the phone.

FIG. 3 is a diagram for illustrating an example of processing executed when the user makes an inquiry on the phone.

FIG. 4 is a diagram for illustrating an example of functions implemented in the inquiry answering system.

FIG. 5 is a view for illustrating an example of an instruction sentence.

FIG. 6 is a flowchart for illustrating an example of processing executed in the inquiry answering system.

FIG. 7 is a diagram illustrating an example of functions implemented in modification examples of the present disclosure.

FIG. 8 is a diagram for illustrating an example of input to and output from a large language model in Modification Example 3.

FIG. 9 is a table for showing an example of an FAQ database.

FIG. 10 is a diagram for illustrating an example of input to and output from the large language model in Modification Example 4.

### DETAILED DESCRIPTION OF THE INVENTION

### 1. Hardware Configuration of Inquiry Answering System

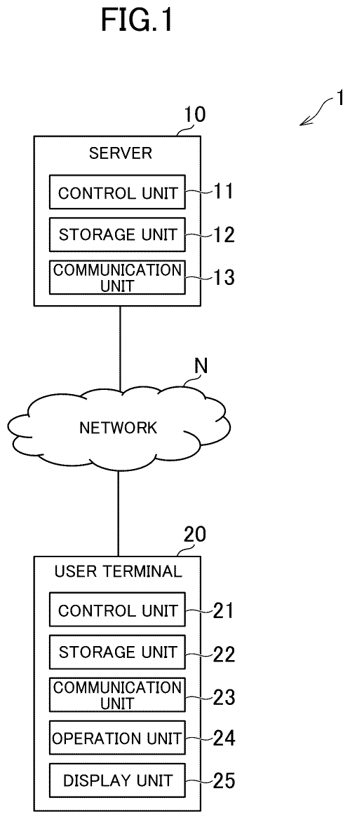

Description is now given of an example of at least one embodiment of an inquiry answering system, an inquiry answering method, and a program according to the present disclosure. FIG. 1 is a diagram for illustrating an example of a hardware configuration of the inquiry answering system. For example, an inquiry answering system 1 includes a server 10 and a user terminal 20. Each of the server 10 and the user terminal 20 is connected to a network N such as a public communication line, the Internet, or a LAN. The number of at least one of the servers 10 or the user terminals 20 may be two or more.

The server 10 is a server computer for a predetermined service. The predetermined service is a service which a user uses or a service the use of which the user is considering. In the at least one embodiment, there is exemplified a case in which an insurance service for providing insurance products to the user corresponds to the predetermined service. Thus, the “insurance service” as used herein can be read as “predetermined service.” The predetermined service is not limited to the insurance service. The predetermined service may be any service. The predetermined service may be an electronic commerce service, a communication service, a financial service, a travel reservation service, a video distribution service, a public service, an administrative service, or another service.

For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication. The server 10 is connected to equipment which receives a phone call for an inquiry from the user, and can acquire voice information indicating content of the phone call. The server 10 itself may receive a phone call for an inquiry from the user through a function of the IP phone.

The user terminal 20 is a computer of the user. For example, the user terminal 20 is a smartphone, a cellular phone not classified into the smartphone, a phone not classified into the cellular phone, a tablet computer, a personal computer, or a wearable terminal. The user terminal 20 includes a control unit 21, a storage unit 22, a communication unit 23, an operation unit 24, and a display unit 25. Hardware configurations of the control unit 21, the storage unit 22, and the communication unit 23 may be the same as those of the control unit 11, the storage unit 12, and the communication unit 13, respectively. The operation unit 24 is an input device such as a touch panel or a mouse. The display unit 25 is a display such as a liquid crystal display or an organic EL display.

Programs stored in the storage units 12 and 22 may be supplied to the server 10 or the user terminal 20 via the network N. Further, the server 10 or the user terminal 20 may include at least one of a reading unit for reading a computer-readable information storage medium (for example, a memory card slot) or an input/output unit (for example, a USB port) through which data is input from or output to external equipment. For example, the program stored on the information storage medium may be supplied to the server 10 or the user terminal 20 via at least one of the reading unit or the input/output unit.

Moreover, it is only required for the inquiry answering system 1 to include at least one computer. The computers included in the inquiry answering system 1 are not limited to those of the example of FIG. 1. For example, the inquiry answering system 1 may include only the server 10. In this case, the user terminal 20 exists outside the inquiry answering system 1. The inquiry answering system 1 may include the server 10 and another computer (for example, a computer of an operator described later) not shown in FIG. 1.

### 2. Overview of Inquiry Answering System

In the at least one embodiment, there is exemplified a case in which the user makes a phone call to a phone number of an inquiry destination in the insurance service from the user terminal 20, to thereby make an inquiry relating to the insurance service. When a call from the user comes to the phone number of the inquiry destination, the call is answered through use of automated voice. The answering through the automated voice may be executed by the server 10 or equipment connected to the server 10.

For example, the user is asked a question “What can I do for you?” through the automated voice. The user makes an inquiry through the voice to the first question asked through the automated voice. The server 10 acquires voice information indicating the voice of the user. The server 10 executes transcription for the voice information to convert the voice of the user to a text. The text obtained through the transcription is hereinafter referred to as “inquiry information.” The server 10 uses a large language model to analyze the inquiry information, and forwards the phone call of the user to an appropriate contact point corresponding to content of the inquiry of the user. Moreover, the server 10 may use the large language model to analyze the inquiry information, may transmit, to the user, a corresponding guidance and a message indicating this guidance, and may transmit, to the user, a link to a webpage indicating this guidance. Moreover, the server 10 may use the large language model to analyze the inquiry information, and may then use the same large language model or another language model to analyze the inquiry information or respond to the inquiry.

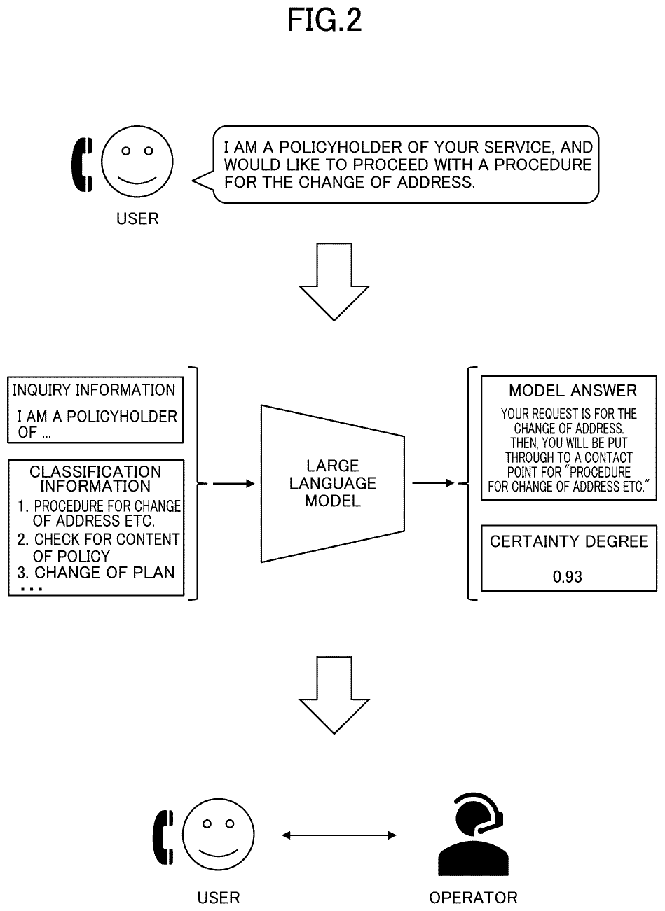

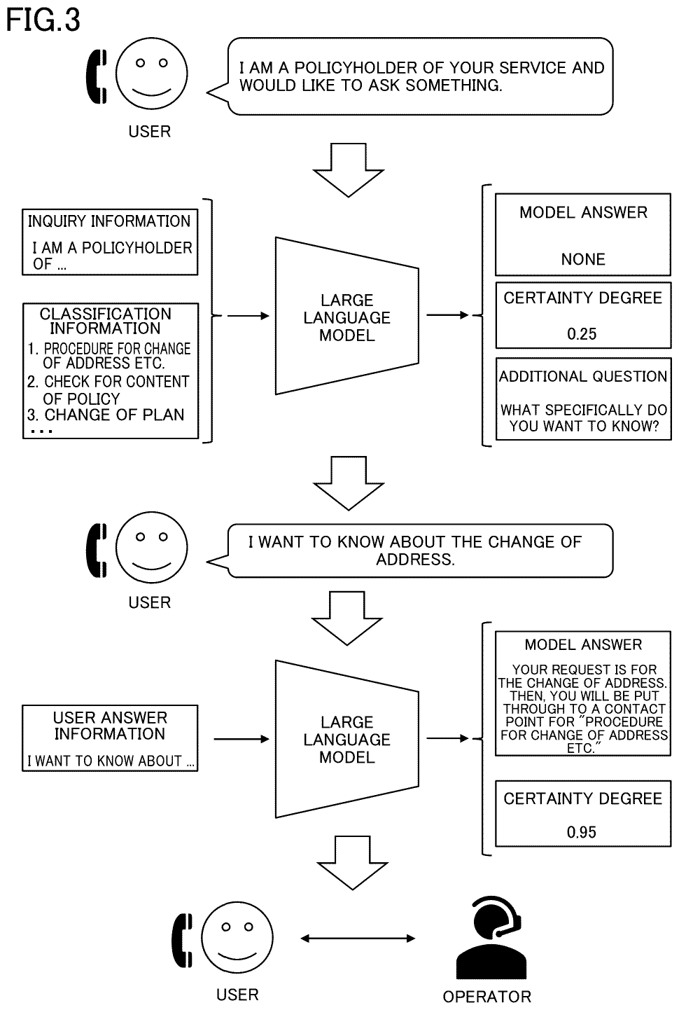

FIG. 2 and FIG. 3 are diagrams for illustrating examples of processing executed when the user makes an inquiry on the phone. In the example of FIG. 2, the user makes an inquiry “I am a policyholder of your service, and would like to proceed with a procedure for the change of address.” to the first question asked through the automated voice. The server 10 inputs the inquiry information indicating a text of the inquiry made by the user and classification information prepared in advance and indicating a classification of the inquiry to the large language model. Details of the large language model are described later.

In the at least one embodiment, there is exemplified a case in which the classification information indicates a contact point of a call center as the classification of the inquiry. For example, the classification information includes a text indicating the contact point of the call center as a classification name such as a contact point to respond to an inquiry for “1. Procedure for change of address etc.,” a contact point to respond to an inquiry for “2. Check for content of policy,” and a contact point to respond to an inquiry for “3. Change of plan.” The large language model estimates an appropriate contact point corresponding to the inquiry from the user based on the inquiry information and the classification information input to the large language model itself. The classification information may include a text as supplementary information for describing or supplementing the classification name. The classification information may include “Others.” “Others” include, for example, a procedure for specific change of address. For example, correct classification may be enabled by holding “Change procedure for phone number,” which is not included in the name “Procedure for change of address etc.,” as not the classification name, but the supplementary information in a form such as a table in association with the classification name. Moreover, for example, a procedure which cannot be handled at the contact point “Procedure for change of address etc.” may be forwarded to the procedure for “Others” by holding a condition corresponding to a specific case of the change of address as the supplementary information in a form such as a table in association with the classification name. As a result, an inquiry estimation of which is difficult only based on the classification name can be classified.

In the at least one embodiment, the large language model calculates a certainty degree of each of the plurality of contact points indicated by the classification information. The certainty degree is an index indicating a degree of certainty held by the large language model. The certainty degree can be considered as accuracy of the estimation by the large language model. The certainty degree is sometimes referred to as “likelihood,” “reliability,” “probability,” or “score.” For example, the certainty degree is expressed as a numerical value. As the certainty degree becomes higher, the large language model estimates the contact point with higher certainty. As the certainty degree becomes lower, the large language model estimates the contact point with lower certainty. The certainty degree may be expressed not in the numerical value, but in a character or a symbol.

For example, when the certainty degree is expressed in a numerical value of from 0 to 1, in the example of FIG. 2, the certainty degree of the contact point “1. Procedure for change of address etc.” estimated by the large language model is 0.93, and hence a probability that the contact point “1. Procedure for change of address etc.” is appropriate as the contact point to respond to the inquiry from the user is high. In the at least one embodiment, the certainty degree is calculated for each of the plurality of contact points. In the example of FIG. 2, out of the certainty degrees of the contact points, the highest certainty degree is 0.93. The certainty degree is high, and hence the probability that the contact point “1. Procedure for change of address etc.” estimated by the large language model is appropriate is high. As illustrated in FIG. 2, the large language model generates an answer “Your request is for the change of address. Then, you will be put through to a contact point for ‘Procedure for change of address etc.’” The certainty degree may be 1.0 when the number of corresponding classifications can be narrowed down to 1, and may be 0.8 when the number of corresponding classifications is 2 or more and is narrowed down to 1 or less, but it is difficult to make determination of matching. Moreover, the certainty degree may be defined in the input to the large language model. In the at least one embodiment, cooperation among programs inside and outside the inquiry answering system can be smoothed by converting the certainty degree to the numerical value. The large language model may execute the output in a specific format such as JSON for simultaneous acquisition of two or more outputs including an answer sentence and the certainty degree and having different purposes, to thereby smooth the cooperation among the programs inside and outside the inquiry answering system.

The answer generated by the large language model is hereinafter referred to as “model answer.” The server 10 converts a text indicating the model answer to voice, and outputs the voice of the model answer as utterance content of the automated voice. When the large language model has a voice reading function, the server 10 is only required to directly output the voice generated by the large language model. A method of outputting the voice to the user may be the same for an additional question described later. The server 10 forwards the phone call of the user to an operator at the contact point “1. Procedure for change of address etc.” estimated by the large language model. The user converses, on the phone, with the operator at the contact point “1. Procedure for change of address etc.”

Meanwhile, when the inquiry from the user is abstract, the certainty degree of any contact point is sometimes low. In the example of FIG. 3, the user makes an inquiry “I am a policyholder of your service, and would like to ask something.” to the first question asked through the automated voice. The inquiry of FIG. 3 does not indicate what the user specifically wants to know, and hence is abstract compared with the inquiry of FIG. 2. In this case, even when the large language model estimates a certain contact point, the certainty degree is low. In the example of FIG. 3, the highest certainty degree out of the certainty degrees of the contact points is 0.25. The certainty degree is low, and hence any contact point estimated by the large language model is highly possibly inappropriate. When the phone call of the user is forwarded to the contact point having a low certainty degree, the phone call may be forwarded to the operator of an inappropriate contact point.

Thus, when the certainty degree is low, the large language model generates the additional question for increasing the certainty degree. In the example of FIG. 3, the large language model generates an additional question “What specifically do you want to know?” In the at least one embodiment, it is assumed that the model answer is not generated when the certainty degree is low, but some model answer may be generated independently of the additional question. Moreover, in FIG. 3, the model answer and the additional question are illustrated separately, but the additional question can also be considered as the answer from the large language model, and can also be considered as a type of the model answer. For example, the user utters an answer to the additional question. The additional question in the at least one embodiment may be a question for clarifying an unclear point regarding the content of the inquiry from the user or a question for clarifying the classification of the content of the inquiry from the user.

The answer made by the user is hereinafter referred to as “user answer.” The text obtained through the transcription from the user answer is hereinafter referred to as “user answer information.” The server 10 inputs the user answer information to the large language model. The large language model again executes the estimation of an appropriate contact point and the calculation of a certainty degree based on the user answer information. In the example of FIG. 3, the user answer is “I want to know about the change of address.” which indicates more specific content than that of the first inquiry. In this case, the certainty degree increases.

For example, it is assumed that the certainty degree of the contact point “1. Procedure for change of address etc.” becomes 0.95 as a result of the additional question generated by the large language model. In this case, the certainty degree is sufficiently high, and hence the large language model generates a model answer “Your request is for the change of address. Then, you will be put through to a contact point for ‘Procedure for change of address etc.’” The server 10 outputs the voice of the model answer and forwards the phone call as in the case of FIG. 2. When the certainty degree does not become sufficiently high even through the first additional question, a second additional question may be generated. An upper limit of the number of times of asking the additional question may be defined. When the certainty degree has not become sufficiently high even after the upper limit number of times is reached, the server 10 may forward the phone call to a contact point which receives a general inquiry.

As described above, the inquiry answering system 1 inputs the inquiry information and the classification information to the large language model, and acquires the model answer and the certainty degree output from the large language model. The inquiry answering system 1 outputs the model answer when the certainty degree is high, and forwards the phone call to the contact point estimated by the large language model. The inquiry answering system 1 causes the large language model to generate the additional question when the certainty degree is low, to thereby increase the certainty degree. As a result, the inquiry answering system 1 can increase the accuracy of the answer to the user. Description is now given of details of the inquiry answering system 1.

### 3. Functions Implemented by Inquiry Answering System

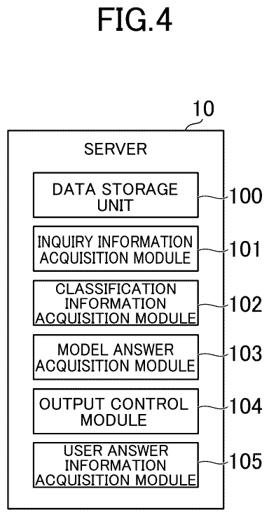

FIG. 4 is a diagram for illustrating an example of functions implemented in the inquiry answering system 1. In FIG. 4, out of functions implemented in the inquiry answering system 1, functions of the server 10 are illustrated. For example, the server 10 includes a data storage unit 100, an inquiry information acquisition module 101, a classification information acquisition module 102, a model answer acquisition module 103, an output control module 104, and a user answer information acquisition module 105. The data storage unit 100 is implemented by the storage unit 12. The inquiry information acquisition module 101, the classification information acquisition module 102, the model answer acquisition module 103, the output control module 104, and the user answer information acquisition module 105 are implemented by the control unit 11.

### [3-1. Data Storage Unit]

The data storage unit 100 stores various types of data required to respond to the inquiry from the user. For example, the data storage unit 100 stores the classification information. The data storage unit 100 may store default instruction sentences to be input to the large language model. In the instruction sentence, a task to be executed by the large language model is indicated. The instruction sentence can be considered as a default prompt prepared on the inquiry answering system 1 side. The classification information may be included in the instruction sentence. For example, in a part of the instruction sentence, the classification information may be indicated. The classification information may be data other than the instruction sentence.

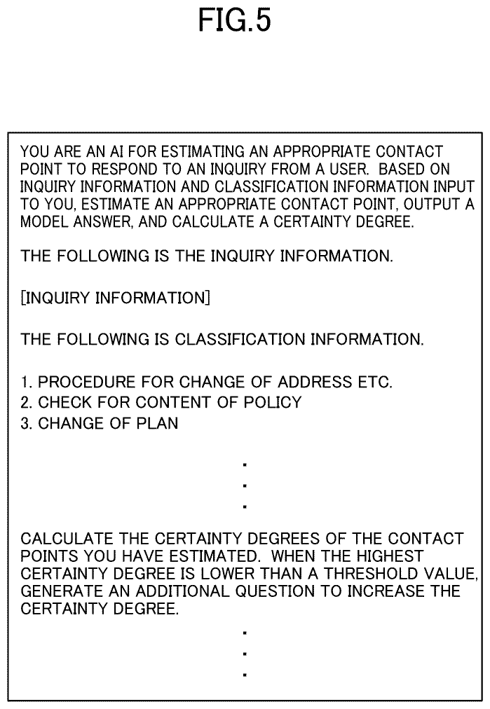

FIG. 5 is a view for illustrating an example of the instruction sentence. In the at least one embodiment, the instruction sentence includes a sentence indicating that the model answer is to be generated based on the inquiry information and the classification information and the certainty degree is to be calculated. For example, the instruction sentence may be a sentence “You are an AI for estimating an appropriate contact point to respond to an inquiry from a user. Based on inquiry information and classification information input to you, estimate an appropriate contact point, output a model answer, and calculate a certainty degree.” The instruction sentence is only required to be a sentence which instructs the large language model to generate the model answer and calculate the certainty degree, and is not limited to the above-mentioned example. The instruction sentence is only required to include wording of giving an instruction to generate the model answer and calculate the certainty degree.

The instruction sentence may include a sentence indicating that an additional question is to be generated when the certainty degree is lower than a threshold value. For example, the instruction sentence may be a sentence “When the highest certainty degree is lower than the threshold value, generate an additional question for increasing the certainty degree.” The threshold value of the certainty degree may also be included in the instruction sentence. In the at least one embodiment, there is exemplified a case in which the threshold value is 0.9, but the threshold value may be any value. For example, the threshold value may be obtained by multiplying the upper limit value of the certainty degree by a predetermined rate (for example, 90%). The instruction sentence for generating the additional question is only required to be a sentence which instructs the large language model to generate the additional question, and is not limited to the above-mentioned example. The instruction sentence for generating the additional question is only required to include wording of giving an instruction to generate the additional question.

In the at least one embodiment, there is exemplified a case in which the external system cooperating with the inquiry answering system 1 manages the large language model. Thus, actual data of the large language model is stored in the external system. The server 10 uses the large language model in the external system via the network N. When the inquiry answering system 1 manages the large language model, the data storage unit 100 may store the actual data of the large language model. The server 10 may use the large language model stored in the data storage unit 100.

The large language model is a model which has learned an enormous number of texts. The large language model includes a program which processes the input text and parameters referred to by this program. When the large language model learns a text for training, the parameters are adjusted. The large language model calculates an embedded expression (feature vector) of the input text based on the parameters, and executes output corresponding to the embedded expression. The large language model may divide the input text into units called tokens, and may calculate the embedded expression of each token. The large language model executes the output corresponding to the sequence of the embedded expressions of the respective tokens.

The large language model may a publicly-known model. For example, the large language model may be generative pre-trained transformer (GPT), bidirectional encoder representations from transformers (BERT), Amazon Bedrock (trademark), language model for dialogue applications (LaMDA), a neural network, Claude (trademark), or another model. The large language model may be a model called generative AI. The large language model may finely be tuned for the inquiry answering system 1, or may be a general-purpose model which is not particularly finely tuned for the inquiry answering system 1.

Moreover, the data stored in the data storage unit 100 is not limited to the above-mentioned example. The data storage unit 100 may store a program which mutually converts the voice and the text to each other. The data storage unit 100 may store information on the threshold value for the certainty degree. When another program other than the large language model calculates the certainty degree, the data storage unit 100 may store the another program which calculates the certainty degree. When the large language model is not managed by the external system, the data storage unit 100 may store the large language model. The data storage unit 100 may store information (for example, an extension phone number of each contact point) for forwarding the phone call of the user to the contact point. The data storage unit 100 may store information indicating the answer output when the certainty degree is low.

### [3-2. Inquiry Information Acquisition Module]

The inquiry information acquisition module 101 acquires the inquiry information relating to the inquiry from the user in the insurance service. In the at least one embodiment, the user makes the inquiry through the voice, and hence the inquiry information acquisition module 101 converts the voice information indicating the voice of the user to the text, to thereby acquire the inquiry information indicating this text. The inquiry information acquisition module 101 may acquire the voice information from the user terminal 20, or may acquire the voice information from equipment which receives the phone call from the user terminal 20.

The transcription of the voice information may be executed in another computer other than the server 10. In this case, the inquiry information acquisition module 101 is only required to acquire, from the another computer, the inquiry information indicating the text obtained by converting the voice. When the large language model can process the voice information, the inquiry information acquisition module 101 may directly acquire the voice information as the inquiry information. That is, the inquiry information may indicate the text or may indicate the voice.

Moreover, the inquiry from the user may be made through another method other than the phone call. For example, the inquiry from the user may be made through a chat in which the message in the text form is input. In this case, the inquiry information acquisition module 101 acquires the inquiry information indicating the message input in the chat. When the inquiry from the user is made through a chat in which the message is input through the voice, the inquiry information acquisition module 101 is only required to acquire the inquiry information through the same method as that for the phone call.

For example, the inquiry from the user may be made through an electronic mail, a short message service (SMS), a social networking service (SNS), a message app, an inquiry form on a website, a search form on a website, or another method. The inquiry information acquisition module 101 may acquire the inquiry information indicating the inquiry from the user made through any one of those methods.

### [3-3. Classification Information Acquisition Module]

The classification information acquisition module 102 acquires the classification information relating to the classification that relates to the inquiry and that is defined in advance in the insurance service. The classification indicated by the classification information is a classification of the inquiry expected in advance. The classification may also be considered as a subject, a type, a genre, or a category of the inquiry. In the classification information, at least one classification is indicated. In the classification information, only one classification may be indicated, or a plurality of classifications may be indicated.

In the at least one embodiment, the classification indicated by the classification information is a classification relating to the contact point to respond to the inquiry. For example, in the call center in the insurance service, a plurality of contact points exist. That is, the call center includes a plurality of contact points divided in accordance with the content of the inquiry so that each contact point can respond to a specific inquiry. Each contact point corresponds to the classification. The classification indicated by the classification information is not limited to the contact point. Another example of the classification is described in modification examples described later.

In the at least one embodiment, the classification information is included in the instruction sentence stored in the data storage unit 100, and hence the classification information acquisition module 102 acquires the instruction sentence from the data storage unit 100, to thereby acquire the classification information. The classification information may be data independent of the instruction sentence. In this case, in the data storage unit 100, the classification information is stored as data independent of the instruction sentence. The classification information acquisition module 102 acquires, from the data storage unit 100, the classification information being data independent of the instruction sentence. The classification information may be stored in another computer other than the server 10, or an information storage medium. In this case, the classification information acquisition module 102 is only required to acquire the classification information from the another computer or the information storage medium.

For example, the classification information acquisition module 102 may search, in the form of retrieval augmented generation (RAG), a database in which various types of classification information are stored, for the classification information to be input to the large language model, may search, in the form of semantic search, this database for the classification information, or may use the embedded expression relating to the text included in the input to the large language for the classification to search model this database information. In this database, the classification information and an index for search are associated with each other. The classification information acquisition module 102 may search this database based on the inquiry information, to thereby acquire the classification information. A specific example of the case in which the classification information is acquired through the search is described in the modification examples described later.

### [3-4. Model Answer Acquisition Module]

The model answer acquisition module 103 inputs the inquiry information and the classification information to the large language model to acquire the model answer relating to the classification and the certainty degree of this classification which are generated by the large language model. In the at least one embodiment, the classification indicated by the classification information is the classification relating to the contact point to respond to the inquiry, and hence the model answer acquisition module 103 acquires, as the model answer, an answer relating to the contact point corresponding to the classification to which the inquiry belongs.

In the at least one embodiment, the large language model is managed by the external system, and hence the model answer acquisition module 103 transmits the inquiry information and the classification information to the external system, to thereby input the inquiry information and the classification information to the large language model. The model answer acquisition module 103 inputs the inquiry information and the classification information as the prompt to the large language model. When the actual data on the large language model is stored in the data storage unit 100, it is only required for the model answer acquisition module 103 to input the inquiry information and the classification information to the large language model stored in the data storage unit 100.

Processing executed by the large language model may be publicly-known processing. For example, when the inquiry information and the classification information are input, the large language model calculates the embedded expressions (feature vectors) of the inquiry information and the classification information based on the parameters adjusted through the training executed in advance. The large language model outputs the model answer as the output corresponding to the embedded expressions. The large language model may divide the inquiry information and the classification information into the units called tokens, and may calculate an embedded expression of each token. In this case, the large language model predicts a continuing portion as required based on the sequence of the embedded expressions of the tokens, and outputs the model answer.

In the at least one embodiment, there is exemplified a case in which the large language model calculates the certainty degree, but the certainty degree may be calculated by another program different from the large language model. In this case, the another program is only required to calculate the certainty degree based on the output from the large language model or information processed internally. The another program may be stored in the external system, or may be stored in the data storage unit 100.

A method of calculating the certainty degree may be a publicly-known method. For example, the large language model sometimes calculates a probability distribution for a token which may appear next in the generation of the token. In this case, the probability distribution indicates to which degree the large language model is certain about the probability of the appearance of each token. This probability distribution may be used as the certainty degree. Moreover, for example, the large language model sometimes calculates a score for a product. The score indicates appropriateness of the product for a context of the prompt. This score may be used as the certainty degree. For the calculation of the certainty degree, a library such as a library (for example, Transformers library) used in a programing language such as Python may be used.

For example, the model answer acquisition module 103 acquires the model answer and the certainty degree from the external system which manages the large language model. When the large language model is stored in the data storage unit 100, the model answer acquisition module 103 is only required to acquire the model answer and the certainty degree output from the large language model stored in the data storage unit 100. When another program which calculates the certainty degree is stored in the data storage unit 100, the model answer acquisition module 103 is only required to acquire the certainty degree calculated by the another program stored in the data storage unit 100.

### [3-5. Output Control Module]

The output control module 104 controls the output of the model answer based on the certainty degree. The control of the output of the model answer is control of whether or not the model answer is to be output. The certainty degree is used as a condition for whether or not the model answer is to be output. The output of the model answer is output to the user. The output to the user includes not only the voice output, but data output (transmission of data). For example, the output control module 104 may output the model answer to the user terminal 20 through voice, or may output the model answer to the user terminal 20 through a text.

For example, the output control 1 module 104 executes determination on whether or not the certainty degree is equal to or higher than a threshold value, and controls the output of the model answer based on the execution result of this determination. It is assumed that threshold value is stored in the data storage unit 100. The output control module 104 outputs the model answer to the user when the certainty degree is determined to be equal to or higher than the threshold value. That is, the output control module 104 outputs the model answer to the user on condition that the certainty degree is determined to be equal to or higher than the threshold value. The output control module 104 does not output the model answer to the user when the certainty degree is determined to be lower than the threshold value.

When the certainty degree of each of the plurality of contact points is calculated, in some cases, there exist a plurality of contact points each having the certainty degree equal to or higher than the threshold value. In this case, the model answer indicates the contact point having the highest certainty degree. The instruction sentence may include such a sentence of instruction that the contact point having the highest certainty degree is to be included in the model answer. The output control module 104 outputs the model answer indicating the contact point having the highest certainty degree. In the at least one embodiment, there is exemplified a case in which the output control module 104 outputs the model answer not including content indicating contact points having the second and subsequent highest certainty degrees, but the output control module 104 may output the model answer which includes the content indicating the contact points having the second and subsequent highest certainty degrees.

For example, when the certainty degree is lower than the threshold value, the output control module 104 acquires an additional question to the user generated by the large language model, and outputs the additional question to the user. In the at least one embodiment, an instruction sentence indicating that the additional question is to be generated when the certainty degree is lower than the threshold value is prepared. Thus, the large language model generates the additional question when the certainty degree is lower than the threshold value. The output control module 104 acquires the additional question generated by the large language model. The output control module 104 may output the additional question through the voice, or may output the additional question through the text, as in the case of the output of the model answer.

In the at least one embodiment, the output control module 104 acquires the additional question which is based on the instruction sentence indicating that the additional question for increasing the certainty degree is to be generated when the certainty degree is lower than the threshold value. The increasing the certainty degree is to increase the certainty degree so that the certainty degree is higher than the acquired certainty degree. For example, the instruction sentence includes a sentence indicating the increase in certainty degree such as “When the certainty degree is lower than the threshold value, generate such an additional question that the certainty degree increases.” The sentence indicating the increase in certainty degree may be other wording which means the increase in certainty degree.

When the instruction sentence indicating that the additional question is to be generated when the certainty degree is lower than the threshold value is not prepared, the output control module 104 is only required to input, when the certainty degree is lower than the threshold value, an instruction sentence indicating that the large language model is to generate the additional question, to the large language model, to thereby cause the large language model to generate the additional question. That is, the acquisition of the model answer and the certainty degree and the acquisition of the additional question may be executed independently of each other, and the processing of the large language model may be executed at two separate times.

Moreover, when the certainty degree of the model output for the first inquiry is lower than the threshold value, the output control module 104 may not particularly output the additional question, and may forward the phone call of the user to the general-purpose contact point. In this case, the output control module 104 does not have the function of outputting the additional question. The server 10 does not include the user answer information acquisition module 105. The aspect in which the output control module 104 does not have the function of outputting the additional question and the server 10 does not include the user answer information acquisition module 105 is also within the scope of the present disclosure. Even in this aspect, the inquiry answering system 1 can prevent the output of the model answer having a low certainty degree as a result of the execution of the control of the model answer based on the certainty degree, and it is possible to increase the accuracy of the answer to the user.

Moreover, the output control module 104 may determine, from fixed sentences defined in advance, a reply such as the additional question to the user, to thereby prevent provision of an unexpected reply to the user. In this case, the data storage unit 100 stores fixed sentence information indicating the fixed sentences defined in advance. The output control module 104 may select the fixed sentence for the large language model. A reply sentence output to the user may be the same as the fixed sentence, or a part of content of the fixed sentence may be changed by the large language model. Moreover, erroneous replacement of characters by the large language model may be prevented by adding an identifier such as a number to the reply sentence in a process of the selection of the reply sentence. Moreover, the generation of the reply by the large language model may be made more appropriate by associating supplementary information with each reply sentence.

### [3-6. User Answer Information Acquisition Module]

The user answer information acquisition module 105 acquires the user answer information relating to the user answer to the additional question from the user. When the additional question is not asked, the processing by the user answer information acquisition module 105 is not executed. The user answer information is input from the user after the first inquiry. The user answer information acquisition module 105 is only required to convert the voice information indicating the voice of the user to a text, to thereby acquire the user answer information indicating this text, in the same manner as in the inquiry information acquisition module 101.

A point that the voice information may be acquired from the user terminal 20, a point that the voice information may be acquired from the equipment which receives the phone call from the user terminal 20, and a point that the transcription for the voice information may be executed by another computer other than the server 10 are also the same as those in the case of the inquiry information acquisition module 101. A point that the user answer may be made through another method other than the phone call and a point that the voice information may be acquired as the user answer information when the large language model supports the voice are also the same as those in the case of the inquiry information acquisition module 101.

In the at least one embodiment, when the certainty degree already acquired is lower than the threshold value, the model answer acquisition module 103 inputs the user answer information to the large language model to again acquire the model answer and the certainty degree. The model answer acquisition module 103 may input, to the large language model, not only the user answer information, but also the inquiry information and the classification information together. The instruction sentence for again acquiring the model answer and the certainty degree may be stored in the data storage unit 100. The model answer acquisition module 103 may input, together with this instruction sentence, the user answer information to the large language model.

In the at least one embodiment, the model answer acquisition module 103 transmits the user answer information to the external system which manages the large language model to input the user answer information to the large language model, to thereby again acquire the model answer and the certainty degree. When the actual data of the large language model is stored in the data storage unit 100, the model answer acquisition module 103 is only required to input the user answer information to the large language model stored in the data storage unit 100 to again acquire the model answer and the certainty degree. The information input to the large language model is different from that at the time of the generation of the first model answer, but the processing itself executed by the large language model may be the same as that at the time of the generation of the first model answer.

In the at least one embodiment, when the certainty degree already acquired is lower than the threshold value, the output control module 104 controls, based on the certainty degree acquired again, the output of the model answer acquired again. The output control module 104 executes determination on whether or not the certainty degree acquired again is equal to or higher than the threshold value, and controls the output of the model answer based on the execution result of this determination. The output control module 104 outputs the model answer acquired again to the user on condition that the certainty degree acquired again is determined to be equal to or higher than the threshold value. The output control module 104 does not output the model answer acquired again to the user when the certainty degree acquired again is lower than the threshold value.

In the at least one embodiment, in the inquiry answering system 1, the acquisition and the output of the additional question, the acquisition of the user answer information, and the acquisition of the model answer and the certainty degree are repeated until the certainty degree becomes equal to or higher than the threshold value. The output control module 104 outputs an answer prepared in advance in the insurance service to the user when the certainty degree has not become equal to or higher than the threshold value even after the acquisition and the output of the additional question, the acquisition of the user answer information, and the acquisition of the model answer and the certainty degree have been repeated a predetermined number of times. The output of the answer prepared in advance includes not only the voice output, but also data output (transmission of data). For example, the output control module 104 may output, to the user terminal 20, the answer prepared in advance through the voice, or may output the answer prepared in advance through the text. Moreover, in the inquiry answering system 1 according to the at least one embodiment, the large language model may generate a summary of the inquiry information, and may include this summary into the output from the large language model and the answer.

The predetermined number of times is an upper limit number of times of the repetition. It is assumed that information indicating the predetermined number of times is stored in the data storage unit 100. It is assumed that information indicating the answer prepared in advance is also stored in the data storage unit 100. The output control module 104 counts the number of times of the repetition for a certain user to determine whether or not the number of times of the repetition reaches a predetermined number of times. When it is determined that the number of times of the repetition has not reached the predetermined number of times, the output control module 104 executes the processing described above, and executes the next repetition. When it is determined that the number of times of the repetition has reached the predetermined number of times, but the certainty degree has not yet become equal to or higher than the threshold value, the output control module 104 outputs the answer prepared in advance to the user.

### 4. Processing Executed in Inquiry Answering System

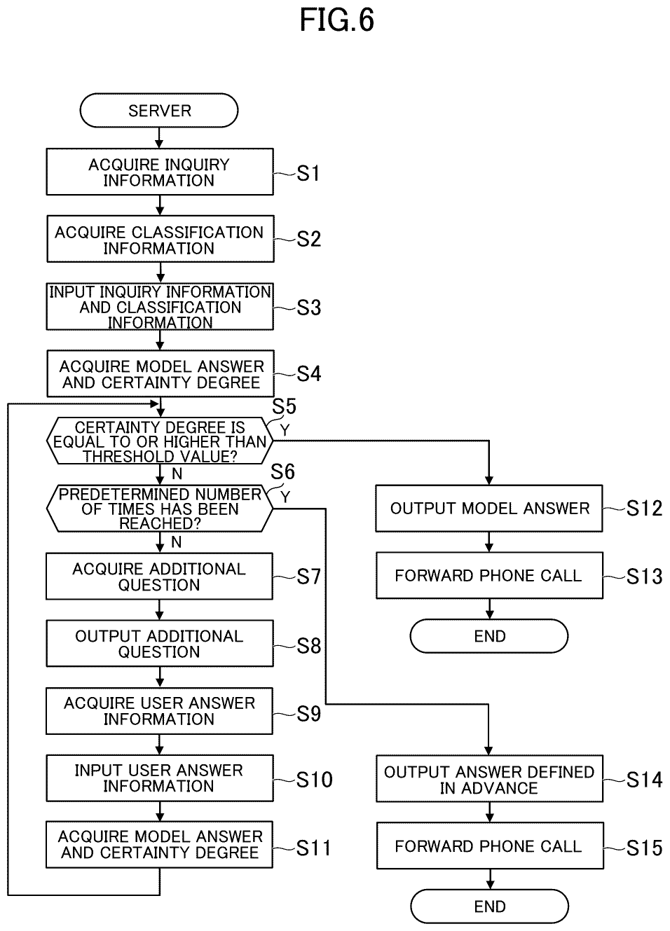

FIG. 6 is a flowchart for illustrating an example of processing executed in the inquiry answering system 1. In FIG. 6, out of processing steps executed in the inquiry answering system 1, processing steps executed on the server 10 are mainly illustrated. The processing of FIG. 6 is executed by the control unit 11 executing the programs stored in the storage unit 12. Steps of FIG. 6 are an example of an inquiry answering method. The processing of FIG. 6 is executed each time the phone call for the inquiry from the user is received at a phone number of the inquiry destination in the insurance service.

As illustrated in FIG. 6, the server 10 converts the voice of the inquiry from the user to the text, to thereby acquire the inquiry information (Step S1). The server 10 acquires the classification information (Step S2). As illustrated in FIG. 5, when the classification information is included in the instruction sentence, the server 10 acquires the instruction sentence, to thereby acquire the classification information in Step S2. The server 10 transmits the inquiry information and the classification information to the external system which manages the large language model, to thereby input the inquiry information and the classification information to the large language model (Step S3).

The server 10 acquires the model answer and the certainty degree from the external system which manages the large language model (Step S4). In Step S4, it is assumed that the additional question has also been generated by the large language model when the certainty degree is lower than the threshold value. The server 10 determines whether or not the certainty degree is equal to or higher than the threshold value (Step S5). When the server 10 determines that the certainty degree is lower than the threshold value in Step S5 (N in Step S5), the server 10 determines whether or not the number of times of the repetition of the processing steps of from Step S7 to Step S11 has reached the predetermined number of times (Step S6). It is assumed that information indicating the number of times of the repetition is stored in the storage unit 12.

When the server 10 determines that the number of times of the repetition has not reached the predetermined number of times in Step S6 (N in Step S6), the server 10 increments the number of times of the repetition, and acquires the additional question generated by the large language model (Step S7). It is assumed that the additional question has been transmitted from the external system at the stage of Step S4. The additional question is not required to be generated together with the model answer and the certainty degree. In this case, in Step S7, the server 10 instructs the large language model to generate the additional question. The server 10 acquires the additional question generated by the large language model.

The server 10 outputs the additional question to the user (Step S8). The server 10 converts, to the text, the voice of the user answer to the additional question, to thereby acquire the user answer information (Step S9). The server 10 transmits the user answer information to the external system which manages the large language model, to thereby input the user answer information to the large language model (Step S10). The server 10 acquires the model answer and the certainty degree from the external system which manages the large language model (Step S11), and the process proceeds to Step S5. The processing steps of from Step S6 to Step S11 are repeated until the certainty degree becomes equal to or higher than the threshold value, or the number of times of the repetition reaches the predetermined number of times.

When the server 10 determines that the certainty degree is equal to or higher than the threshold value in Step S5 (Y in Step S5), the server 10 outputs the model answer to the user (Step S12). The server 10 forwards the phone call to the contact point having the highest certainty degree (Step S13), and this processing is finished. The user converses, on the phone, with the operator at the contact point of the forward destination.

When the server 10 determines that the number of times of the repetition has reached the predetermined number of times in Step S6 (Y in Step S6), the server 10 outputs the answer defined in advance to the user (Step S14). The server 10 forwards the phone call to the contact point which receives a general inquiry (Step S15), and this processing is finished. The user converses, on the phone, with the operator at the contact point of the forward destination.

### 5. Summary of at Least One Embodiment

The inquiry answering system 1 according to the at least one embodiment acquires the inquiry information. The inquiry answering system 1 acquires the classification information. The inquiry answering system 1 inputs the inquiry information and the classification information to the large language model to acquire the model answer and the certainty degree. The inquiry answering system 1 controls the output of the model answer based on the certainty degree. As a result, the inquiry answering system 1 does not unconditionally output the model answer, but controls the output of the model answer based on the certainty degree of the classification to which the inquiry from the user belongs, and hence can increase the accuracy of the answer to the user. For example, when the inquiry answering system 1 determines whether or not the model answer is to be output based on the certainty degree, the inquiry answering system 1 can prevent the model answer from being output even when the certainty degree is low. When the inquiry answering system 1 outputs the model answer having a high certainty degree, the inquiry answering system 1 can output the model answer having high accuracy of estimation by the large language model.

Moreover, the inquiry answering system 1 outputs the model answer to the user when the certainty degree is equal to or higher than the threshold value. The inquiry answering system 1 acquires the additional question to the user generated by the large language model, and outputs the additional question to the user when the certainty degree is lower than the threshold value. The inquiry answering system 1 acquires the user answer information. The inquiry answering system 1 inputs the user answer information to the large language model, and again acquires the model answer and the certainty degree. The inquiry answering system 1 controls the output of the model answer acquired again based on the certainty degree acquired again. As a result, the inquiry answering system 1 outputs the model answer when the certainty degree becomes equal to or higher than the threshold value, and hence can increase the accuracy of the answer to the user. The inquiry answering system 1 can use the additional question to acquire a chance to increase the certainty degree even when the certainty degree is lower than the threshold value, and can thus increase the accuracy of the answer to the user.

Moreover, the inquiry answering system 1 acquires the additional question which is based on the instruction sentence indicating that the additional question for increasing the certainty degree is to be generated when the certainty degree is lower than the threshold value. As a result, the increase in certainty degree is facilitated by the additional question, and hence the inquiry answering system 1 is more likely to acquire the model answer having higher accuracy, and can thus increase the accuracy of the answer to the user.

Further, in the inquiry answering system 1, the acquisition and the output of the additional question, the acquisition of the user answer information, and the acquisition of the model answer and the certainty degree are repeated until the certainty degree becomes equal to or higher than the threshold value. The inquiry answering system 1 outputs an answer prepared in advance in the insurance service to the user when the certainty degree has not become equal to or higher than the threshold value even after the generation and the output of the additional question, the acquisition of the user answer information, and the acquisition of the model answer and the certainty degree have been repeated a predetermined number of times. As a result, for example, the inquiry answering system 1 can prevent the user from receiving additional questions an excessively large number of times, and can thus increase convenience of the user.

Moreover, the classification indicated by the classification information is the classification relating to the contact point to respond to the inquiry. The inquiry answering system 1 acquires, as the model answer, the answer relating to the contact point corresponding to the classification to which the inquiry belongs. As a result, the inquiry answering system 1 can output a more appropriate contact point as the model answer. The inquiry answering system 1 can guide the user to the contact point suitable for the inquiry from the user.

### 6. Modification Examples

The present disclosure is not limited to the at least one embodiment described above. The present disclosure can be modified suitably without departing from the spirit of the present disclosure.

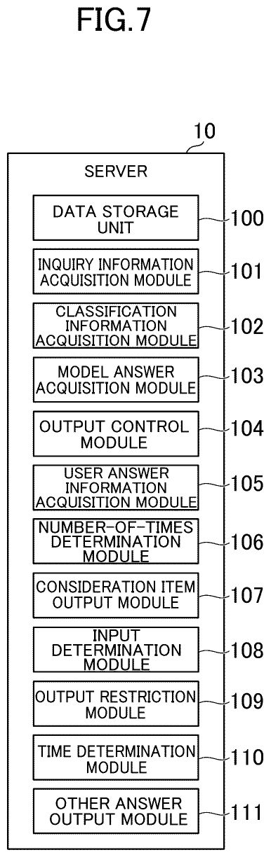

FIG. 7 is a diagram for illustrating an example of functions implemented in the modification examples. For example, the server 10 includes a number-of-times determination module 106, a consideration item output module 107, an input determination module 108, an output restriction module 109, a time determination module 110, and an other answer output module 111. Each of the number-of-times determination module 106, the consideration item output module 107, the input determination module 108, the output restriction module 109, the time determination module 110, and the other answer output module 111 is implemented by the control unit 11.

### 6-1. Modification Example 1

For example, in the at least one embodiment, there has been exemplified the case in which the predetermined number of times corresponding to the upper limit number of the repetition is the number of times defined in advance. Depending on the certainty degree, even when the number of times of the repetition has reached the predetermined number of times, the certainty degree may become equal to or higher than the threshold value when some more additional questions are output to the user. For example, it is assumed that the threshold value for the certainty degree is 0.9, the predetermined number of times is three times, and the certainty degree changes in a sequence of 0.12, 0.45, and 0.89. In the example in the at least one embodiment, when the certainty degree does not become equal to or higher than 0.9 after the third additional question, the predetermined answer is output, and the phone call is forwarded to the general-purpose contact point. However, when such a change in certainty degree occurs, the server 10 may be able to guide the user to an appropriate contact point through one more additional question. Thus, in Modification Example 1, the predetermined number of times in accordance with the certainty degree is determined.

The inquiry answering system 1 in Modification Example 1 includes the number-of-times determination module 106. The number-of-times determination module 106 determines the predetermined number based on the certainty degree. When the predetermined number of times is defined in advance, changing the predetermined number of times defined in advance corresponds to the determination of the predetermined number of times. When the predetermined number of times is not defined in advance, generation of the predetermined number of times corresponds to the determination of the predetermined number of times. The output control module 104 controls the repetition of the acquisition of the model answer and the certainty degree and the like based on the predetermined number of times determined by the number-of-times determination module 106.

For example, the number-of-times determination module 106 may determine the predetermined number of times based on a difference obtained by subtracting the certainty degree from the threshold value. This certainty degree is a current certainty degree. For example, this certainty degree may be a certainty degree at the time when the predetermined number of times defined in advance is reached or a certainty degree having been acquired up to the time. The number-of-times determination module 106 may determine the predetermined number of times when the number of times of the repetition has reached the number of times defined in advance, or may determine the predetermined number of times before the number of times of the repetition reaches the number of times defined in advance (for example, at a timing when the model answer to the first inquiry is generated).

The predetermined difference a value that corresponds to a threshold value at the time of the determination of the predetermined number of times. It is assumed that information indicating the predetermined difference is stored in the data storage unit 100. In the number-of-times determination module 106, a state in which the difference obtained by subtracting the certainty degree from the threshold value is equal to or larger than the predetermined difference means that the current certainty degree is greatly apart from the threshold value, and hence the additional question may be ineffective. A state in which the difference obtained by subtracting the certainty degree from the threshold value is smaller than the predetermined difference means that the current certainty degree is close to the threshold value, and hence the additional question may be effective.

Thus, the number-of-times determination module 106 may determine the predetermined number of times so that the predetermined number of times becomes larger as the difference obtained by subtracting the certainty degree from the threshold value becomes smaller. That is, the number-of-times determination module 106 may determine the predetermined number of times so that the predetermined number of times becomes smaller as the difference obtained by subtracting the certainty degree from the threshold value becomes larger. In other words, the predetermined number of times may be determined so that the predetermined number of times is larger in a case in which the difference obtained by subtracting the certainty degree from the threshold value is less than the predetermined difference than that in a case in which this difference is equal to or larger than the predetermined difference. That is, the number-of-times determination module 106 may determine the predetermined number of times so that the predetermined number of times is smaller in the case in which the difference obtained by subtracting the certainty degree from the threshold value is equal to or larger than the predetermined difference than that in the case in which this difference is smaller than the predetermined difference.

It is assumed that relationship data indicating a relationship between the difference obtained by subtracting the certainty degree from the threshold value and the predetermined number of times is stored in the data storage unit 100. The number-of-times determination module 106 is only required to determine the predetermined number of times based on the certainty degree and the relationship data. The number-of-times determination module 106 calculates the difference obtained by subtracting the certainty degree from the threshold value, and determines the predetermined number of times so that the predetermined number of times is the predetermined number of times associated with this difference in the relationship data. Moreover, the method of determining the predetermined number of times by the number-of-times determination module 106 is not limited to the above-mentioned example. For example, the number-of-times determination module 106 is only required to determine the predetermined number of times based on the change in certainty degree. The number-of-times determination module 106 may determine the predetermined number of times so that the predetermined number of times increases when an amount of the increase in certainty degree is equal to or larger than a predetermined amount. The number-of-times determination module 106 may increase the predetermined number of times when the certainty degree has become higher than another threshold value, and may reduce the predetermined number of times when the certainty degree has become lower than the another threshold value. As a result, the number-of-times determination module 106 can increase the predetermined number of times even when, for example, the absolute values of the certainty degrees relating to the answers on an early stage are low, but the absolute values of the certainty degrees relating to subsequent answers are high.

The number-of-times determination module 106 may determine the predetermined number of times based on a change rate of the certainty degree. The number-of-times determination module 106 may acquire the maximum value of the certainty degrees each time the answer is generated by the large language model. The number-of-times determination module 106 may increase the predetermined number of times when a change rate of this maximum value exceeds a predetermined change rate, and may reduce the predetermined number of times when the change rate of this maximum value falls below the predetermined change rate. Here, the number-of-times determination module 106 may determine the predetermined number of times based on not only the change rate of the successive maximum values, but the change rate of the maximum values relating to the answers generated within a unit time. Moreover, here, the number-of-times determination module 106 may determine the predetermined number of times based on a statistical value including a value of an average of the certainty degrees in place of the maximum value. Moreover, here, the number-of-times determination module 106 may determine the predetermined number of times based on a change rate of the certainty degree relating to a common classification in place of this maximum value. Moreover, here, the number-of-times determination module 106 may determine the predetermined number of times based on a change amount of the certainty degree in place of the change rate of the certainty degree. The number-of-times determination module 106 may increase the number of times when, for example, the initial value relating to the predetermined number of times is three times, the maximum value of the certainty degree changes in such a sequence as 0.2, 0.2, and 0.6, and the change rate from 0.2 to 0.6 exceeds the predetermined change rate. Moreover, the number-of-times determination module 106 may reduce the predetermined number of times when, for example, the initial value relating to the predetermined number of times is set to five times, the maximum value of the certainty degree changes in such a sequence as 0.2, 0.2, and 0.2, and the change rate of the maximum value remains lower than the predetermined change rate.

The number-of-times determination module 106 may change the predetermined number of times based on sentiment of the user estimated by inputting a text, voice information, or video information corresponding to the inquiry information to an existing model (a language model, a voice recognition model, an image recognition model, and the like). Specifically, the number-of-times determination module 106 may reduce this predetermined number of times in order to reduce the number of interactions (conversations) with the user when this existing model estimates that the sentiment of the user is negative as a binary classification of being positive and negative. Moreover, the number-of-times determination module 106 may change the predetermined number of times based on the number of characters relating to the inquiry information from the user or the answer generated by the large language model, or may change the predetermined number of times based on time taken by the input of the inquiry information from the user or the generation of the answer by the large language model. Specifically, when the number of characters relating to the inquiry information falls below a predetermined number, this predetermined number of times may be increased in order to allow an increase in number of interactions with the user. The predetermined number of times may be an upper limit number (allowable number) of times of the repetition per unit time. Moreover, the number-of-times determination module 106 may determine this predetermined number of times based on whether the number of interactions within a unit time exceeds, falls below, or remains at a predetermined value. Moreover, the number-of-times determination module 106 may determine this predetermined number of times based on whether a frequency of the interactions within a unit time exceeds, falls below, or remains at a predetermined value. Moreover, the number-of-times determination module 106 may determine this predetermined number of times based on whether a speed (pace) of the interactions within a unit time exceeds, falls below, or remains at a predetermined value. The number-of-times determination module 106 may increase this predetermined number of times when, for example, three or more interactions take place in one minute, and hence the number of times, the frequency, or the speed (pace) of the interactions within a unit time exceeds a predetermined value. Here, “remains at the predetermined value” refers to a state in which a difference between a certain value relating to the interactions within a unit time and a predetermined value falls below another predetermined value.

The inquiry answering system 1 according to Modification Example 1 determines the predetermined number of times based on the certainty degree. As a result, the inquiry answering system 1 can determine, based on the certainty degree, the number of times of the repetition of the processing of acquiring the model answer and the like, and hence it is possible to increase the accuracy of the answer to the user. For example, the inquiry answering system 1 increases the predetermined number of times when the certainty degree almost becomes equal to or higher than the threshold value, thereby being able to give the user the chance of acquiring the model answer having the certainty degree equal to or higher than the threshold value. Moreover, the inquiry answering system 1 according to Modification Example 1 may determine the predetermined number of times based on, in place of or in addition to the certainty degree, the estimated sentiment of the user, the number of characters relating to the inquiry information from the user or the answer generated by the large language model, the time taken by the input of the inquiry information from the user or the generation of the answer by the large language model, and/or any value relating to the interactions within a unit time. As a result, the inquiry answering system 1 can determine the number of times of the repetition of the processing such as the acquisition of the model answer and the like based on whether or not the interactions with the user are steadily in progress under a state in which the stress of the user is reduced.

### 6-2. Modification Example 2

For example, the information input to the large language model is not limited to the example in the at least one embodiment. In Modification Example 2, there is exemplified a case in which the additional question is repeated until the certainty degree becomes equal to or higher than the threshold value as in the at least one embodiment or Modification Example 1. In this case, the user makes the first inquiry, and provides the user answer to the additional question asked after the first inquiry, and hence histories of those may be input to the large language model.

The model answer acquisition module 103 in Modification Example 2 further inputs the history relating to the inquiry information to the large language model to again acquire the model answer and the certainty degree. The history relating to the inquiry information may include only the inquiry information, but may include not only the inquiry information, but also the user answer information indicating the user answer to the additional question asked after the first inquiry. When the additional question is asked a plurality of times, the history relating to the inquiry information may include the user answer information relating to each of the plurality of times of the additional questions.

For example, when the first additional question is asked, the history relating to the inquiry information includes only the inquiry information indicating the first inquiry. In this case, the model answer acquisition module 103 inputs, to the large language model, the inquiry information together with the user answer information indicating the user answer to the first additional question. The information input to the large language model is different from that in the at least one embodiment, but the processing executed until the large language model provides the output corresponding to the input may be the same as that in the at least one embodiment.

For example, when the second and subsequent additional questions have been asked, the history relating to the inquiry information includes the inquiry information indicating the first inquiry and the user answer information relating to the user answers to the additional questions asked up to the relevant time. In this case, the model answer acquisition module 103 inputs, to the large language model, together with the user answer information indicating the user answer to the newest additional question, the inquiry information and the user answer information relating to the user answers provided to the additional questions asked up to the relevant time. Also in this case, the information input to the large language model is different from that in the at least one embodiment, but the processing executed until the large language model provides the output corresponding to the input may be the same as that in the at least one embodiment.

The inquiry answering system 1 according to Modification Example 2 further inputs the history relating to the inquiry information to the large language model to again acquire the model answer and the certainty degree. As a result, the inquiry answering system 1 can acquire the model answer and the certainty degree based on the history of the input provided by the user, and can thus output the model answer following a context of the interactions with the user.

### 6-3. Modification Example 3

For example, as in the at least one embodiment, when the large language model estimates an appropriate contact point, and a consideration item to be considered by this contact point is transmitted to this contact point, a subsequent task of responding to the inquiry may be smoothed. The inquiry of the user and the user answers up to the relevant time are input to the large language model, and hence it may be possible to estimate the consideration item to be considered by the contact point. The large language model may estimate appropriate another large language model in place of an appropriate contact point. The appropriate another large language model refers to another large language model capable of generating a reply corresponding to a reply made by an appropriate contact point. Moreover, the large language model may estimate appropriate other input to the large language model in place of an appropriate contact point.

Thus, there is exemplified a case in which the model answer acquisition module 103 in Modification Example 3 further acquires the consideration item that is to be considered by the contact point and that is generated by the large language model. The consideration item is information to be provided to the contact point. The consideration item is a text indicating content to be considered by the contact point. The consideration item is not limited to the text, and may be other information such as an image. The consideration item may be information in any form which can be generated by the large language model.

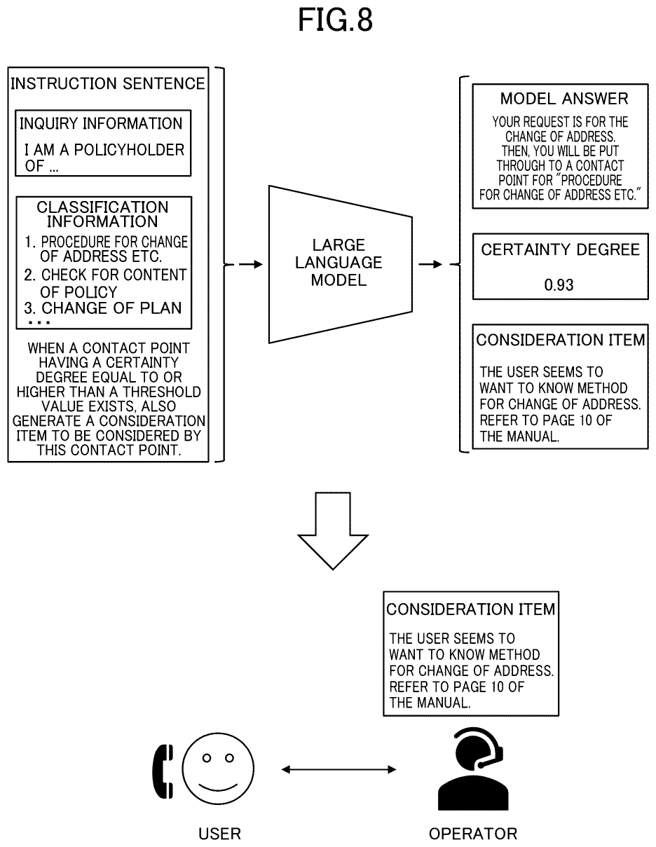

FIG. 8 is a diagram for illustrating an example of input to and output from the large language model in Modification Example 3. As illustrated in the upper portion of FIG. 8, the instruction sentence input to the large language model includes a sentence indicating that the consideration item to be considered by the contact point estimated by the large language model is to be generated. For example, the instruction sentence includes a sentence “When a contact point having a certainty degree equal to or higher than a threshold value exists, also generate a consideration item to be considered by this contact point.” The instruction sentence is only required to be a sentence which instructs the large language model to generate the consideration item, and is not limited to the above-mentioned example. The instruction sentence is only required to include wording of giving an instruction to generate the consideration item. To the large language model, a manual to be referred to by the operator at the contact point may be input together with the instruction sentence.

For example, the model answer acquisition module 103 inputs, together with the instruction sentence, the inquiry information and the classification information to the large language model. When the additional question is asked, the model answer acquisition module 103 may also input the additional question to the large language model. The large language model calculates embedded expressions thereof based on the parameters adjusted through training, and provides output corresponding to the embedded expressions. In Modification Example 3, the output also includes the consideration item for the contact point. The model answer acquisition module 103 acquires the consideration item for the contact point output from the large language model. The large language model may not output the consideration item for the contact point when the certainty degree is lower than the threshold value, and may output the consideration item for the contact point when the certainty degree is equal to or higher than the threshold value. The large language model may output the consideration item for the contact point not particularly depending on the certainty degree.

The inquiry answering system 1 in Modification Example 3 includes the consideration item output module 107. The consideration item output module 107 outputs the consideration item to the contact point. The output to the contact point includes not only the voice output, but also the data output (transmission of data). For example, the consideration item output module 107 may output, to a terminal at the contact point, the consideration item through the voice or through the text. The terminal at the contact point may be a terminal operated by the operator or a terminal operated by another person other than the operator. As illustrated in the lower portion of FIG. 8, the consideration item output module 107 may display a screen indicating the consideration item on the terminal at the contact point. The consideration item output module 107 transmits data indicating the consideration item to the terminal at the contact point, to thereby display this screen.

The inquiry answering system 1 according to Modification Example 3 further acquires the consideration item that is to be considered by the contact point and that is generated by the large language model. The inquiry answering system 1 outputs the consideration item to the contact point. As a result, the inquiry answering system 1 can output the information useful for the contact point, and can thus support a task of the contact point. Moreover, the inquiry answering system 1 according to Modification Example 3 may transmit this consideration item to another large language model in place of the contact point. Specifically, the inquiry answering system 1 according to Modification Example 3 may include the consideration item into input to the another large language model serving as the contact point estimated by the large language model. The reply made by the large language model may include wording in a fixed form meaning “A succeeding operator will take over this case.” Moreover, the inquiry answering system 1 according to Modification Example 3 may reflect this consideration item in other input to the large language model in place of the contact point.

### 6-4. Modification Example 4

For example, in the at least one embodiment, there has been exemplified the case in which the contact point to respond to the inquiry from the user corresponds to the classification. The classification indicated by the classification information is not limited to the example in the at least one embodiment. In Modification Example 4, there is exemplified a case in which the classifications are classifications of frequently asked questions (FAQs) in the insurance service. The FAQ is a combination of a question frequently asked in the insurance service and an answer to this question. In Modification Example 4, there is exemplified a case in which one combination corresponds the classification, but a plurality of combinations may belong to one classification. The data storage unit 100 in Modification Example 4 stores an FAQ database in which a plurality of combinations are stored.

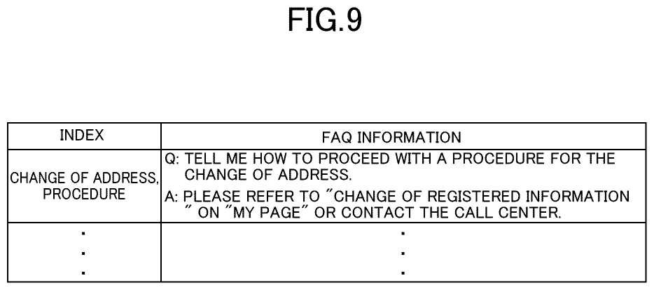

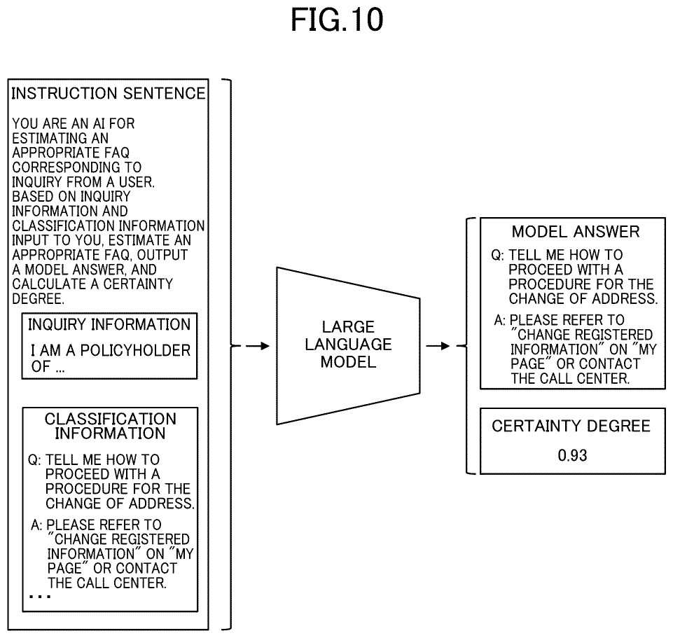

FIG. 9 is a table for showing an example of the FAQ database. As shown in FIG. 9, in the FAQ database, an index for search and FAQ information being actual data on the FAQ are associated with each other. The index is information referred to in the search in Modification Example 5 described later. For example, the index is a keyword for search or a vector indicating content of the FAQ. In Modification Example 4, there is exemplified a case in which the search is not particularly executed, and hence the index is not required to be stored in the FAQ database. The FAQ information may be in any data format. For example, the FAQ information may be in a CSV format, a text format, a markup language format, a document format, an image format, a video format, or another format. The FAQ database is created by an administrator in the insurance service. The classification information acquisition module 102 in Modification Example 4 acquires the actual data on each FAQ stored in the FAQ database as the classification information. FIG. 10 is a diagram for illustrating an example of input to and output from the large language model in Modification Example 4. The model answer acquisition module 103 in Modification Example 4 acquires, as the model answer, an answer in the FAQ corresponding to the classification to which the inquiry belongs. As illustrated in FIG. 10, the instruction sentence input to the large language model includes a sentence indicating that an appropriate classification as the classification of the FAQ indicated by the classification information is to be estimated. For example, the instruction sentence may be a sentence “You are an AI for estimating an appropriate FAQ corresponding to an inquiry from a user. Based on inquiry information and classification information input to you, estimate an appropriate FAQ, output a model answer, and calculate a certainty degree.” The instruction sentence is only required to be a sentence which instructs the large language model to estimate an appropriate FAQ and calculate the certainty degree, and is not limited to the above-mentioned example. The instruction sentence is only required to include wording of giving an instruction to estimate an appropriate FAQ and calculate the certainty degree.

The large language model in Modification Example 4 calculates, based on the parameters adjusted through training, embedded expressions of the above-mentioned instruction sentence, and the inquiry information and the classification information input to the large language model itself. The large language model predicts a continuing portion as required based on the calculated embedded expressions, and outputs the model answer indicating an FAQ estimated as appropriate. When each FAQ corresponds to the classification, the large language model may output the certainty degree for each FAQ. The model answer acquisition module 103 acquires the model answer output from the large language model.

As illustrated in FIG. 10, the model answer indicates the FAQ estimated as appropriate by the large language model. The model answer may directly indicate the content of the FAQ, or may indicate content obtained by the large language model editing the FAQ. When the certainty degree is lower than the threshold value, the output control module 104 may output the additional question for increasing the certainty degree in the same manner as in the at least one embodiment. When the number of times of the repetition reaches the predetermined number of times, the output control module 104 may allow the inquiry to manually be responded to by, for example, forwarding the phone call from the user to the operator or forwarding the inquiry made through a tool such as the chat to the operator.

The inquiry answering system 1 according to Modification Example 4 acquires, as the model answer, the answer in the FAQ corresponding to the classification to which the inquiry belongs. As a result, the inquiry answering system 1 can output a more appropriate FAQ as the model answer. The inquiry answering system 1 can output, to the user, the information for solving the inquiry from the user.

### 6-5. Modification Example 5

For example, in Modification Example 4, when a large number of FAQs are stored in the FAQ database, the large number of FAQs may be input as the classification information to the large language model. In this case, the large language model may be unable to recognize the large number of FAQs, and hence the estimation accuracy of the large language model may decrease. Thus, the classification information acquisition module 102 in Modification Example 5 searches, based on the inquiry information, the FAQ database storing the FAQ information relating to the FAQs, to thereby acquire the classification information. The processing described in Modification Example 5 is processing to which a method called RAG is applied.

For example, the classification information acquisition module 102 uses the inquiry information as a query to search the FAQ database based on a predetermined search algorithm. The predetermined search algorithm may be the same as an algorithm used in a publicly-known search engine. The classification information acquisition module 102 acquires, as the classification information, at least one FAQ hit in the search. For example, when a degree of matching between the query and the index is calculated as a score, the classification information acquisition module 102 may acquire, as the classification information, all FAQs each having the score equal to or higher than a threshold value, or may acquire, as the classification information, FAQS having the highest scores down to a predetermined place in the descending order. The inquiry answering system 1 according to Modification Example 5 may, in order to allow the inquiry information to be treated as the query, generate the additional question, acquire the answer of the user to the additional question, and then search the FAQ database. Here, the inquiry answering system 1 may execute, based on the classification information input to the large language model, the generation of the additional question and acquisition of the user answer to the additional question until the text included in the inquiry information matches the classification included in this classification information. Moreover, the inquiry answering system 1 may execute the generation of the additional question and the acquisition of the user answer to the additional question in order to clarify, among a plurality of classifications which are included in this classification information and which may be confused with one another, a classification to which the text included in the inquiry information matches. The inquiry answering system 1 according to Modification Example 5 may correct, convert, or shape, based at least on a conversation history including the user answer to the additional question generated by the large language model, the inquiry information as a query so that the query is appropriate as search wording for semantic search in the FAQ database. At this time, the inquiry information may be corrected, converted, or shaped as the query based on, for example, a dedicated large language model and input thereto.

The model answer acquisition module 103 in Modification Example 5 inputs, as the classification information, to the large language model, the FAQ acquired through the search executed by the classification information acquisition module 102 among the FAQs stored in the FAQ database. Modification Example 5 is different from Modification Example 4 in such a point that the classification information input to the large language model is the FAQ acquired through the search executed by the classification information acquisition module 102, but is the same as Modification Example 4 in the processing executed by the large language model and in such a point that the model answer acquisition module 103 acquires the output from the large language model.

The inquiry answering system 1 according to Modification Example 5 searches the FAQ database in which the pieces of FAQ information relating to the FAQs are stored based on the inquiry information, to thereby acquire the classification information. As a result, the inquiry answering system 1 inputs more appropriate classification information to the large language model, and hence the estimation accuracy of the large language model can be increased. The inquiry answering system 1 can output, to the user, the information suitable for the inquiry from the user. Moreover, the inquiry answering system 1 according to Modification Example 5 appropriately narrows down the classification information, thereby being able to increase a response quality of the response to the user in a voice phone conversation in which listing the classification information is difficult. The inquiry answering system 1 according to Modification Example 5 may execute, when the classification information is appropriately narrowed down, text processing of generating a summary relating to the output to the user at such a level that recognition of the user is facilitated, and may include the summary into the output to the user.

### 6-6. Modification Example 6

For example, the user may provide new input during the acquisition of the model answer and the certainty degree or the output of the model answer. In the case of the phone call as in the at least one embodiment, the new input is utterance of the user. In the case of transmission and reception of a message in the chat or the like, the new input is input of the message by the user. When the processing on the inquiry answering system 1 side continues even after the user provides the new input, the user may be confused. Thus, in Modification Example 6, there is exemplified a case in which the acquisition of the model answer and the certainty degree or the output of the model answer is temporarily stopped when the user provides the new input.

The inquiry answering system 1 according to Modification Example 6 includes the input determination module 108 and the output restriction module 109. The input determination module 108 determines whether or not the new input from the user has been received during the acquisition of the model answer and the certainty degree or the output of the model answer. The period of the acquisition of the model answer and the certainty degree is the period of the processing executed by a model answer processing module. The period from a start of the processing executed by the model answer processing module to an end of the processing corresponds to the period of the acquisition of the model answer and the certainty degree. The period of the output of the model answer is the period of the processing executed by an answer control module. The period from a start of the processing executed by the answer control module to an end of the processing corresponds the period of the output of the model answer.

For example, in the case of the phone call as in the at least one embodiment, the input determination module 108 determines whether or not new utterance from the user has been received during the acquisition of the model answer and the certainty degree or the output of the model answer. The input determination module 108 is only required to acquire the voice information indicating the content of the phone conversation with the user, and to determine whether or not the new utterance from the user has been received based on the voice information. In the case of the transmission and the reception of the message in the chat or the like, the input determination module 108 determines whether or not the input of a new message from the user has been received during the acquisition of the model answer and the certainty degree or the output of the model answer. The input determination module 108 is only required to acquire message input information indicating the input of the message by the user from the user terminal 20, and to determine whether or not the input of the new message from the user has been received based on the message input information.

The output restriction module 109 in Modification Example 6 restricts the output of the model answer when it is determined that the new input has been received during the acquisition or the output. The restriction of the output of the model answer is to stop the processing for the output of the model answer. For example, the output restriction module 109 stops the processing executed by the model answer acquisition module 103 when the model answer and the certainty degree are being acquired. The output restriction module 109 stops the processing executed by the output control module 104 when the model answer is being output. The stop of those processing steps is only required to be implemented by a program code indicating the processing being executed is to be stopped.

For example, when the new input is provided by the user, the model answer acquisition module 103 acquires new input information indicating the new input. The new input information is different from the inquiry information in such a point that the new input information indicates not the first inquiry but the new input, but is the same as the inquiry information in other points. The model answer acquisition module 103 may cause the large language model to estimate whether or not the new input information and content of the conversation up to the relevant time have the same topic. The large language model may output a score indicating whether or not the new input information and the content have the same topic.

For example, the output control module 104 may control the output to the user based on the score. For example, when the score is equal to or higher than a threshold value, the output control module 104 may control the output to the user so that the conversation continues to the suspended conversation while providing a response “Regarding the answer to your request, the answer is to be continued.” When the score is lower than the threshold value, the output control module 104 may control the output to the user so that the output corresponding not to the suspended conversation but to the new input is provided while providing a response “Regarding the answer to your request, an answer to the current input is to be provided.” In this case, the output control module 104 may resume the original output when the output corresponding to the new input is completed.

The inquiry answering system 1 according to Modification Example 6 determines whether or not the new input has been received from the user during the acquisition of the model answer and the certainty degree or the output of the model answer. The inquiry answering system 1 restricts the output of the model answer when it is determined that the new input has been received during the acquisition or the output. As a result, the inquiry answering system 1 can prevent the case in which, even after the user provides the new input, the processing on the inquiry answering system 1 side continues and the user is thus confused.

### 6-7. Modification Example 7

For example, the processing executed by the large language model may take time depending on the content of the inquiry from the user. In this case, when no response to the user is provided, the user may be confused. Thus, in Modification Example 7, when a duration required for the response (for example, the model answer or the additional question) to the user continues, and the duration consequently becomes equal to or longer than a threshold value, an answer such as “Processing for your request is in progress, so please wait a little longer.” is output.

The inquiry answering system 1 according to Modification Example 7 includes the time determination module 110 and the other answer output module 111. The time determination module 110 determines whether or not a period of time is required to acquire the model answer and the certainty degree. For example, the time determination module 110 measures, as the duration, a period of time since a model answering processing module started the processing. As a method of measuring time, a code employed in a publicly-known programing language may be used to measure the time. The time determination module 110 determines whether or not the duration has become equal to or longer than the threshold value while the response to the user has not been output. The time determination module 110 determines that the period of time is not required for the acquisition of the model answer and the certainty degree when the response to the user is output before the duration becomes equal to or longer than the threshold value. The time determination module 110 determines that the period of time is required for the acquisition of the model answer and the certainty degree when the duration is determined to have become equal to or longer than the threshold value while the response to the user has not been output.

Moreover, the determination method used by the time determination module 110 is not limited to the above-mentioned example. For example, the time determination module 110 may determine whether or not the duration has become equal to or longer than the threshold value while the output has not been acquired from the large language model. The time determination module 110 determines that the period of time is not required for the acquisition of the model answer and the certainty degree when the output from the large language model is acquired before the duration becomes equal to or longer than the threshold value. The time determination module 110 determines that the period of time is required for the acquisition of the model answer and the certainty degree when the duration is determined to have become equal to or longer than the threshold value while the output from the large language model has not been acquired.

Moreover, the time determination module 110 does not measure the time, but may cause the large language model to estimate the duration required for the output of the model answer and the certainty degree. The time determination module 110 determines whether or not the duration estimated by the large language model is equal to or longer than the threshold value. The time determination module 110 determines that the period of time is not required for the acquisition of the model answer and the certainty degree when the duration estimated by the large language model is determined to be shorter than the threshold value. The time determination module 110 determines that the period of time is required for the acquisition of the model answer and the certainty degree when the duration estimated by the large language model is determined to be equal to or longer than the threshold value.

The other answer output module 111 outputs, to the user, another answer different from the model answer when it is determined that a period of time is required to acquire the model answer and the certainty degree. In Modification Example 7, there is exemplified a case in which the another answer is an answer defined in advance, but the another answer may be generated by the large language model. When the another answer is an answer defined in advance, it is assumed that other-answer information indicating the another answer is stored in the data storage unit 100. The other answer output module 111 outputs the another answer to the user based on the other-answer information. The output of the another answer to the user includes not only the voice output, but also the data output (transmission of data). For example, the other answer output module 111 may output, to the user terminal 20, the another answer through the voice, or may output the another answer through the text.

The inquiry answering system 1 according to Modification Example 7 determines whether or not a period of time is required to acquire the model answer and the certainty degree. The inquiry answering system 1 outputs, to the user, the another answer different from the model answer when it is determined that a period of time is required to acquire the model answer and the certainty degree. As a result, the inquiry answering system 1 can prevent a case in which the user receives no response and is thus confused, and can consequently increase the convenience of the user.

### 6-8. Modification Example 8

For example, when an amount of content of the model answer generated by the large language model is large, an information amount output to the user is also large. Thus, when the amount of content of the model answer is equal to or larger than a threshold value, the output control module 104 may cause the large language model to generate a summary of the model answer, and may output the summary to the user. In Modification Example 8, there is exemplified a case in which the model answer is the answer indicating an appropriate contact point described in the at least one embodiment, but the model answer may be the answer in the FAQ described in Modification Example 4.

The amount of content of the model answer is a length of the model answer. For example, when the model answer is expressed through the text, the amount of content of the model answer is the number of characters, the number of lines, the number of paragraphs, or the number of pages. When the model answer is expressed through the voice, the amount of content of the model answer is a length of a reproduction time of the voice. When the model answer is expressed in another form other than the text and the voice, the amount of content of the model answer is a data amount of the model answer.

For example, the instruction sentence to be input to the large language model in Modification Example 8 includes a sentence indicating that the large language model is to generate the summary of the model answer when the amount of content of the model answer generated by the large language model is equal to or larger than the threshold value. For example, the instruction sentence includes a sentence “When the amount of content of the model answer generated by you is equal to or larger than the threshold value, output a summary of this model answer.” The instruction sentence is only required to be a sentence of giving an instruction to generate the summary of the model answer, and is not limited to the above-mentioned example. The instruction sentence is only required to include wording of giving an instruction to generate the summary of the model answer. The large language model in Modification Example 8 may include content of this model answer not included in the summary of this model answer into subsequent model answers in accordance with a request from the user in response to a sentence “Do you have any other unclear points?” added to the summary of this model answer.

For example, the output control module 104 controls the output of the model answer based on the certainty degree when the amount of content of the model answer is smaller than the threshold value. The output control module 104 controls the output of the model answer to the user when the amount of content of the model answer is smaller than the threshold value and the certainty degree is equal to or higher than the threshold value. The output control module 104 outputs the summary of the model answer to the user when the amount of content of the model answer is equal to or larger than the threshold value and the certainty degree is equal to or higher than the threshold value. When the certainty degree is lower than the threshold value, processing similar to that in the at least one embodiment may be executed.

The inquiry answering system 1 according to Modification Example 8 causes the large language model to generate the summary of the model answer when the amount of content of the model answer is equal to or larger than the threshold value, and outputs the generated summary to the user. As a result, the inquiry answering system 1 can prevent the model answer having redundant content from being output to the user, and can thus increase the convenience of the user. The inquiry answering system 1 according to Modification Example 8 may separately input, to the large language model, an instruction sentence intended to check whether or not the model answer deviates from a flow (context) of the interactions with the user in place of the amount of content of the model answer, to thereby check absence or presence of the deviation. Moreover, the inquiry answering system 1 according to Modification Example 8 may separately input, to the large language model, an instruction sentence intended to check whether or not the output from the large language model includes a text or a term not included in the FAQ database, to thereby check absence or presence of occurrence of hallucination. When occurrence of this deviation or this hallucination is confirmed, the inquiry answering system 1 according to Modification Example 8 may cause the large language model to again generate the reply. At this time, the inquiry answering system 1 according to Modification Example 8 may invoke escalation to a manned inquiry answering or a large language model for escalation and an instruction therefor.

### 6-9. Other Modification Examples

For example, the modification examples described above may be combined with one another.

For example, the functions described as being implemented by the server 10 may be implemented by the user terminal 20 or another computer. The function described as being implemented by the server 10 may be implemented by a plurality of computers in a distributed manner.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An inquiry answering system, comprising at least one processor configured to:
acquire inquiry information relating to an inquiry from a user in a predetermined service;
acquire classification information relating to a classification that relates to the inquiry and that is defined in advance in the predetermined service;
input the inquiry information and the classification information to a large language model to acquire a model answer relating to the classification and a certainty degree of the classification which are generated by the large language model; and
control output of the model answer based on the certainty degree.

2. The inquiry answering system according to claim 1, wherein the at least one processor is configured to:
output the model answer to the user when the certainty degree is equal to or higher than a threshold value;
acquire an additional question to the user generated by the large language model when the certainty degree is lower than the threshold value, and output the additional question to the user;
acquire user answer information relating to a user answer from the user to the additional question;
input the user answer information to the large language model to again acquire the model answer and the certainty degree; and
control, based on the certainty degree acquired again, output of the model answer acquired again.

3. The inquiry answering system according to claim 2, wherein the at least one processor is configured to acquire the additional question which is based on an instruction sentence indicating that the additional question for increasing the certainty degree is to be generated when the certainty degree is lower than the threshold value.

4. The inquiry answering system according to claim 2,
wherein the acquisition and the output of the additional question, the acquisition of the user answer information, and the acquisition of the model answer and the certainty degree are repeated until the certainty degree becomes equal to or higher than the threshold value in the inquiry answering system, and
wherein the at least one processor is configured to output an answer prepared in advance in the predetermined service to the user when the certainty degree is lower than the threshold value even after the acquisition and the output of the additional question, the acquisition of the user answer information, and the acquisition of the model answer and the certainty degree are repeated a predetermined number of times.

5. The inquiry answering system according to claim 4, wherein the at least one processor is configured to determine the predetermined number of times based on the certainty degree.

6. The inquiry answering system according to claim 2, wherein the at least one processor is configured to further input a history relating to the inquiry information to the large language model to again acquire the model answer and the certainty degree.

7. The inquiry answering system according to claim 1,
wherein the classification is a classification relating to a contact point to respond to the inquiry, and
wherein the at least one processor is configured to acquire, as the model answer, an answer relating to the contact point corresponding to the classification to which the inquiry belongs.

8. The inquiry answering system according to claim 7, wherein the at least one processor is configured to:
further acquire a consideration item that is to be considered by the contact point and that is generated by the large language model; and
output the consideration item to the contact point.

9. The inquiry answering system according to claim 1,
wherein the classification is a classification of a frequently asked question (FAQ) in the predetermined service, and
wherein the at least one processor is configured to acquire, as the model answer, an answer in the FAQ corresponding to the classification to which the inquiry belongs.

10. The inquiry answering system according to claim 9, wherein the at least one processor is configured to search an FAQ database that stores FAQ information relating to the FAQ based on the inquiry information, to thereby acquire the classification information.

11. The inquiry answering system according to claim 1, wherein the at least one processor is configured to:
determine whether new input is received from the user during one of the acquisition of the model answer and the certainty degree or the output of the model answer; and
restrict the output of the model answer when the at least one processor determines that the new input is received during one of the acquisition or the output.

12. The inquiry answering system according to claim 1, wherein the at least one processor is configured to:
determine whether a period of time is required to acquire the model answer and the certainty degree; and
output, to the user, another answer different from the model answer when the at least one processor determines that a period of time is required to acquire the model answer and the certainty degree.

13. The inquiry answering system according to claim 1, wherein the at least one processor is configured to cause the large language model to generate a summary of the model answer when an amount of content of the model answer is equal to or larger than a threshold value, and to output the summary to the user.

14. An inquiry answering method, comprising:
acquiring inquiry information relating to an inquiry from a user in a predetermined service;
acquiring classification information relating to a classification that relates to the inquiry and that is defined in advance in the predetermined service;
inputting the inquiry information and the classification information to a large language model to acquire a model answer relating to the classification and a certainty degree of the classification which are generated by the large language model; and
controlling output of the model answer based on the certainty degree.

15. A non-transitory information storage medium having stored thereon a program for causing a computer to:
acquire inquiry information relating to an inquiry from a user in a predetermined service;
acquire classification information relating to a classification that relates to the inquiry and that is defined in advance in the predetermined service;
input the inquiry information and the classification information to a large language model to acquire a model answer relating to the classification and a certainty degree of the classification which are generated by the large language model; and
control output of the model answer based on the certainty degree.
